(19) United States
(12) Patent Application Publication
(10) Pub. No.: US 2025/0328317 A1
(43) Pub. Date: Oct. 23, 2025

(54) NAVIGATION FROM EXTERNAL CODE SNIPPET SYMBOLS

(71) Applicant: Microsoft Technology Licensing, LLC, Redmond, WA (US)

(72) Inventors: Matthew Joseph BIERNER, Lake Forest Park, WA (US); Johannes RIEKEN, Zürich (CH); Kai-Uwe MAETZEL, Seattle, WA (US); SteVen Michael BATTEN, Renton, WA (US)

(21) Appl. No.: 18/638,971

(22) Filed: Apr. 18, 2024

(51) Int. Cl. G06F 8/33; G06F 9/54; G06F 40/103

(52) U.S. Cl. CPC G06F 8/33; G06F 9/543; G06F 40/103

(57) ABSTRACT

Some embodiments find locations of targets which are related to a symbol in a source code snippet, when the snippet is external to a project codebase. Finding a target's location allows user-directed or proactive automatic navigation from the symbol into the codebase, display of data type, signature, and other semantic information of the symbol, proactive automatic creation of an import statement for a definition of the symbol, and other utilizations of the target location in an enhanced editor or enhanced debugger or another tool. In some scenarios, the external snippet is generated by an artificial intelligence agent, using part of the codebase as context. Some embodiments find a target of an external snippet's symbol in another external snippet, allowing a tool utilization that is informed by the project codebase even when both snippets are outside the project codebase.

### BACKGROUND

Computer program source code often includes a variety of identifiers, which are sometimes referred to as “symbols”. The meanings associated with a given symbol depend on one or more of: the program's source code (sometimes referred to as the “codebase”), the programming language(s) the program source code is written in, and the program's computational environment. Generally, a given symbol represents a variable, a data type, a method, or another artifact, or an operation on one or more artifacts, in addition to representing the symbol's name as a string of characters. Multiple meanings are often associated with a given symbol. For example, a symbol representing a variable is also associated with the variable's data type and associated with the variable's current value. Likewise, a symbol representing a class is also associated with a declaration of the class (which does not allocate memory), a definition of the class (which does allocate memory), or both, and with instances of the class.

Some software development tools automatically gather some of the source code that is relevant to a given symbol in a codebase, and make that source code available on demand to developers who are working with that codebase. However, there is still room for improvement in the identification, organization, and presentation of the code and the meanings that are relevant to a given symbol in a computer program source code.

### SUMMARY

Some embodiments address technical challenges arising in software development. One challenge is how to effectively integrate, into a program and a development workflow, source code which is produced by an artificial intelligence agent. One challenge is how to effectively integrate, into a program and a development workflow, source code which is copied from outside a codebase, e.g., copied from a web page. Another challenge is how to improve user-directed navigation from a source code snippet outside a project's codebase to relevant locations within the project. Other technical challenges are also addressed herein.

Some embodiments taught herein provide or utilize external symbol navigation technology in an environment which includes a project workspace. The workspace includes a project codebase, an agent interface to an artificial intelligence agent, and a software development tool. In operation, some embodiments (a) receive a selection of a symbol, the symbol contained in a snippet of source code, the snippet situated inside the workspace but outside the codebase, (b) find a location of a target, the target related to the symbol, the location outside the snippet and inside the workspace, the location unknown to the software development tool prior to the find, and (c) supply the location of the target to the software development tool. The software development tool then utilizes the location in a software development workflow, e.g., as part of user-directed navigation, symbol information display, source code creation or modification, or other computational actions.

Other technical activities, technical characteristics, and technical benefits pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. Subject matter scope is defined with claims as properly understood, and to the extent this Summary conflicts with the claims, the claims should prevail.

### BRIEF DESCRIPTION OF THE DRAWINGS

A more particular description will be given with reference to the attached drawings. These drawings only illustrate selected aspects and thus do not fully determine coverage or scope.

FIG. 1 is a diagram illustrating aspects of computer systems and also illustrating configured storage media, including some aspects generally suitable for embodiments which include or use external symbol navigation (ESN) functionality;

FIG. 2 is a block diagram illustrating aspects of a family of enhanced systems which are each configured with ESN functionality;

FIG. 3 is a block diagram illustrating aspects of another family of systems which are each enhanced with ESN functionality, including some systems with software which upon execution performs a first family of ESN methods;

FIG. 4 is a block diagram illustrating aspects of ESN functionality in an architecture with an artificial intelligence agent outside a project workspace;

FIG. 5 is a block diagram illustrating aspects of ESN functionality in an architecture with an artificial intelligence agent inside a project workspace;

FIG. 6 is a block diagram illustrating some additional aspects related to ESN functionality;

FIG. 7 is a block diagram illustrating some additional aspects related to symbol information;

FIG. 8 is a block diagram illustrating some additional aspects related to source code;

FIG. 9 is a flowchart illustrating a second family of ESN methods; and

FIG. 10 is a flowchart further illustrating ESN methods, and incorporating as options the steps of FIGS. 2, 3, 4, 5, and 9.

### DETAILED DESCRIPTION

### Overview

Some teachings described herein were motivated by technical challenges faced and insights gained during efforts to improve technology for software development tools, such as source code editors and debuggers. These challenges and insights provided some motivations, but the teachings herein are not limited in their scope or applicability to these particular tools, motivational challenges, solutions, or insights.

Some software tools provide code editing features or code analysis features to aid development of a program's codebase, such as code completion suggestions, semantic highlighting that displays different kinds of identifiers in different colors (e.g., method names, method parameters, reserved words, data types, . . . ), hovering or other displays of semantic information such as data types and function signatures, or navigational features within a codebase such as “go to definition” to go to a definition of a symbol and “go to type definition” to go to a definition of a symbol's type. A symbol is designated by an identifier in a source code of the codebase, and represents a variable, data type, method, object, class, or other artifact of the program. In some Microsoft products, some or all of these code editing features or static analysis features are sometimes referred to as IntelliSense® features or as IntelliCode™ features (marks of Microsoft Corporation).

However, some of these code editing features or code analysis features are not available for symbols which appear in external source code that is not part of the codebase, such as source code that is output from an artificial intelligence (AI) agent. AI-produced snippets have been in a separate world, apart from the codebase, without the support of editing and analysis data structures and operations. In some cases, code editing features or code analysis features are not entirely absent, but only work within an AI-produced block of self-contained code. For example, sometimes source code is produced by Microsoft Copilot™ software or GitHub Copilot™ software in a chat window, outside any file that holds the codebase source code (marks of Microsoft Corporation, GitHub, Inc., respectively).

Even when a snippet of source code produced by an AI agent was computed by the AI agent from a context that includes the codebase, a user could not navigate from the agent-produced code into a corresponding definition, declaration, or other relevant location in the codebase, or in a separate AI-produced snippet outside the codebase, due to the absence of editing and analysis data structures and operations. Some embodiments described herein close that gap in navigation functionality, e.g., by combining functionality used for navigation inside a codebase with some processing of a context that was submitted to the AI agent.

Some embodiments described herein utilize or provide an ESN method which includes receiving a selection of a symbol, the symbol contained in a snippet of source code, the snippet situated inside a project workspace but outside the project's codebase; finding a location of a target, the target related to the symbol, the location outside the snippet and inside the workspace; and supplying the location of the target to a software development tool.

This ESN functionality has the technical benefit of facilitating software development while conserving computational resources and avoiding program coding errors. The ESN functionality integrates the external snippet into the project's development workflow, by providing symbols of the external snippet with adaptations of at least some (and in some cases all) of the information display and source code navigation support mechanisms and structures that are provided to symbols within the codebase.

In one example, an instance of a symbol in an AI-produced snippet in an AI agent's chat view has an internal edit and analysis support data structure containing a pointer to the symbol's definition in the codebase, even though the symbol instance resides outside the codebase. In another example, an instance of a symbol in an AI-produced snippet in the AI agent's chat view has an internal edit and analysis support data structure 740 containing a pointer to the symbol's definition in a second external snippet elsewhere in the chat view, even though 20 the symbol instance and the second external snippet both reside outside the codebase. In each of these examples, the internal edit and analysis support data structure of the symbol corresponds to data structure representations created for in-codebase symbols by code editing features or code static analysis features. The edit and analysis support data structure 740 supports source code editing, or source code static analysis, or both. In some embodiments the symbol's internal edit and analysis support data structure is created by features which are adapted for use with external snippets, e.g., features 738 adapted to treat source code outside a codebase as if it is part of the codebase for code editing and static analysis purposes but not part of the codebase for executable code generation purposes or version control purposes.

Under one alternative approach, the tool performs a string search to find codebase code that is potentially related to a symbol named in a snippet of AI-produced 404 code. However, in many scenarios a string search will return extraneous results, because string searches merely match character strings without regard to code parse tree structure, data types, and other semantic information of the snippet and the symbol. When the symbol name is relatively unusual, e.g., “ConvertGreenFilterToRedFilter”, the likelihood of extraneous string search results is lower, although even then results from within comments 806 can be returned. But when the symbol name is relatively common, e.g., “node” or “key” or “result”, the likelihood of extraneous string search results is high. Reviewing or somehow filtering the string search results manually imposes a burden and developers and increases the risk of errors, e.g., data type mismatches or matching but overlooked instances of a symbol in a codebase.

In some embodiments, these information display and source code navigation support mechanisms and structures are provided for the external snippet symbol without requiring any supplemental action by a developer, such as copy and paste actions. Under another alternative approach potentially used to force provision of the data structures, the developer would manually copy and paste the code snippet, or would copy and paste the symbol alone, from the external location to make a copy of the symbol or its snippet somewhere in the codebase.

But this alternative approach invites coding errors due to unintended consequences such as clashing identifier scopes or a file “touch” that changes a file's modification timestamp and thus triggers automatic build efforts. In some cases, this alternative approach will cause compilation errors in a codebase file that previously had no errors. Sometimes the copy will be inadvertently left in a codebase file as an undocumented piece of source code whose relationship to the other source code in that file is unclear, because the purpose of the copy was to bring the snippet or symbol to any location inside the codebase, not necessarily to the forgotten copy's specific location. Under the alternative approach, computational resources will be wasted generating executable code for the copy, or trying to, or determining that such executable code would never be called. Copying and pasting the symbol or its external snippet also imposes extra work on the developer, and consumes computational resources that would not be spent when an embodiment provides code editing and static analysis for the symbol in place within the external snippet as is taught here.

Some embodiments described herein utilize or provide an ESN method wherein the symbol has a name, the code snippet is in an output produced by an artificial intelligence agent in response to a context submitted to the artificial intelligence agent, and finding the location of the target includes at least one of: searching for the symbol name in the context, searching for the symbol in a symbol list created using a context code snippet from the context, or searching for the symbol in a parse tree created using a context code snippet from the context.

This ESN functionality has the technical benefit of efficiently and accurately finding occurrences of the symbol, which in turn helps conserve computational resources and avoid coding errors when providing code editing or static analysis for the symbol in place within the AI agent output as taught here. Some embodiments look through the context from a workspace that was passed to an AI agent for use in producing the output that contains the snippet. In some scenarios, this context includes workspace file names, workspace symbol names, and snippets of code from the workspace. Using this information, the embodiment tries to resolve the symbol to a set of specific code locations in the workspace where the symbol occurs. For workspace symbols in the context, the embodiment looks for exact matches using, e.g., string comparison. For code snippets in the context, the embodiment scans the context snippets structurally for occurrences of the target symbol. By using snippet structures 610 such as the symbol list and the parse tree, the embodiment scans only symbols from the snippet and avoids accidentally matching a word inside a longer string or inside a comment.

Some embodiments described herein utilize or provide an ESN method wherein the code snippet is in an output produced by an artificial intelligence agent in response to a context submitted to the artificial intelligence agent, and finding the location of the target includes identifying at least two candidate locations of the target, and choosing a particular candidate location as the location of the target. The choosing is computed from at least one of: an indication whether the particular candidate location is in the context submitted to the artificial intelligence agent, or an indication whether a data type employed at the particular candidate location matches a data type employed in the code snippet.

This ESN functionality has the technical benefit of efficiently and accurately finding the most relevant occurrences of the symbol, which in turn helps conserve computational resources and avoid coding errors when providing code editing or static analysis for the symbol in place within the AI agent output as taught here. Some embodiments identify multiple candidate locations, and try to choose the location that is most relevant. In some embodiments, symbols defined in the workspace context snippets themselves are deemed more relevant than symbols defined elsewhere. In some embodiments, a symbol whose data type matches how the symbol is used in the AI-produced source code is deemed more relevant than symbols whose data types do not match. Some embodiments also weight these priorities relative to one another, e.g., such that matching data types takes precedence over occurring in a workspace context snippet, or vice versa.

In some embodiments, the snippet containing the symbol resides in a chat view in a user interface of a software development tool. This ESN functionality has the technical benefit of integrating AI agent chat views and other chat views into the source code editing and static analysis capabilities of the software development tool. This integration is accomplished without imposing a supplemental action requirement on the developer, and without spending computational resources on automatic builds that are triggered by any saved edit of a codebase source code file.

In one example scenario, a developer views the external snippet in the chat view, and exercises the embodiment's external snippet editing and analysis functionality to navigate from a method call in the snippet to see the method's signature with an accompanying comment about the method's intended effects and expected parameters. Based on the information displayed, the developer decides that the snippet will not be made a part of the codebase. This information is displayed, and the decision is reached, without actually copying the snippet into any codebase file. No build is triggered, because the snippet was not copied into the codebase. No separate copy and paste operation by the developer was needed to construct the code editing and analysis data structures that supported gathering and displaying the method signature and the accompanying comment.

In some embodiments, the snippet containing the symbol is a first snippet, the first snippet resides in the agent interface, and the target location is in a second snippet which also resides in the agent interface. This ESN functionality has the technical benefit of integrating multiple snippets in an AI agent interface into the source code editing and static analysis capabilities of the software development tool, which creates more options for considering source code for inclusion in a project codebase.

In one example scenario, the AI agent produces a snippet containing a symbol foo( ), which is then provided by an embodiment with an edit and analysis data structure (the parentheses indicate that foo is a method or another callable routine, and do not necessarily appear as “( )” in the snippet). Utilizing the edit and analysis data structure, hovering over foo( ) in the agent interface causes the embodiment to display a message along the lines of “foo( ) is not defined in this project codebase.” Then the developer commands the AI agent “Give me three different definitions of foo( ) that are consistent with this project.” In response, the AI agent creates three definitions of foo( ) using at least part of the project codebase as context, and outputs those definitions to the agent interface as source code. The embodiment updates all the occurrences of foo( ) in the interface with respective edit and analysis data structures, which point to one another in the interface, and also point to related symbols in the project codebase, e.g., definitions of types which are mentioned in the foo( ) definitions.

By providing the edit and analysis data structures to multiple snippets in the interface, the embodiment beneficially allows the developer to consider multiple competing definitions of foo( ) at the same time, together with their respective relationships to the codebase, without actually including any of those definitions in the codebase. Indeed, including two or more of the competing definitions in the codebase would generate errors, because compilers treat different simultaneously visible definitions of a single symbol as an erroneous condition.

In some embodiments, utilizing the location of the target in the software development tool includes at least one of: furnishing the codebase with a piece of source code which contains a definition of the symbol, or furnishing the codebase with a source code statement to import a definition of the symbol. This ESN functionality has the technical benefit of automatically producing and adding code that makes the symbol definition visible to the compiler when the symbol is added to the project codebase.

In one example scenario, the AI agent produces a snippet containing a symbol foo( ), which is then provided by an embodiment with an edit and analysis data structure. Utilizing the edit and analysis data structure, the embodiment locates a definition of foo( ) in the codebase, in a file mylib.pyd. When the developer copies the snippet into a codebase file mywidget.py, the embodiment checks mywidget.py for an import statement importing mylib, does not find such a statement, and automatically and proactively adds “import mylib” at the top of mywidget.py. If this statement had not been added to import mylib into mywidget, then the effort to build and run mywidget would have generated an error along the lines of “foo( ): not defined”. More generally, when a snippet is copied from an external location into the codebase, some embodiments automatically produce source code and add it to provide any missing definitions of symbols in the snippet. Adding the import statement(s) automatically conserves computational resources and developer time by preventing the error(s) that would otherwise occur.

These and other benefits will be apparent to one of skill from the teachings provided herein.

### Operating Environments

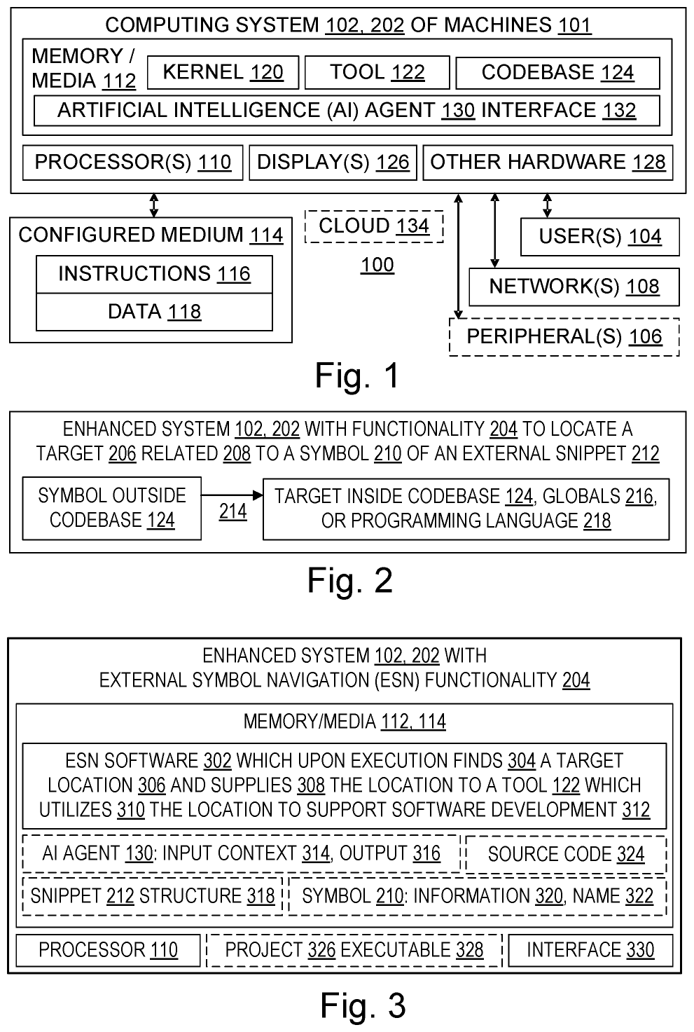

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 134. An individual machine is a computer system, and a network or other non-empty group of cooperating machines is also a computer system. A given computer system 102 may be configured for end-users, e.g., with applications, for administrators, as a server, as a distributed processing node, and/or in other ways.

Human users 104 sometimes interact with a computer system 102 user interface by using displays 126, keyboards 106, and other peripherals 106, via typed text, touch, voice, movement, computer vision, gestures, and/or other forms of I/O. Virtual reality or augmented reality or both functionalities are provided by a system 102 in some embodiments. A screen 126 is a removable peripheral 106 in some embodiments and is an integral part of the system 102 in some embodiments. The user interface supports interaction between an embodiment and one or more human users. In some embodiments, the user interface includes one or more of: a command line interface, a graphical user interface (GUI), natural user interface (NUI), voice command interface, or other user interface (UI) presentations, presented as distinct options or integrated.

System administrators, network administrators, cloud administrators, security analysts and other security personnel, operations personnel, developers, testers, engineers, auditors, and end-users are each a particular type of human user 104. In some embodiments, automated agents, scripts, playback software, devices, and the like running or otherwise serving on behalf of one or more humans also have user accounts, e.g., service accounts. Sometimes a user account is created or otherwise provisioned as a human user account but in practice is used primarily or solely by one or more services; such an account is a de facto service account. Although a distinction could be made, “service account” and “machine-driven account” are used interchangeably herein with no limitation to any particular vendor.

The distinction between human-driven accounts and machine-driven accounts is a different distinction than the distinction between attacker-driven accounts and non-attacker driven accounts. A particular human-driven account may be attacker-driven, or non-attacker-driven, at a given point in time. Similarly, a particular machine-driven account may be attacker-driven, or non-attacker-driven, at a given point in time.

Although for convenience, examples and claims herein sometimes speak in terms of accounts, “account” means “account or session or both” unless stated otherwise. In this disclosure, including in the claims and elsewhere, a statement about activity by “the user account or the user session” does not mean that both the user account and the user session must be present. Instead, such a statement is to be understood as a pair of corresponding but distinct statements given as alternatives, one statement being about activity by the user account, and the other statement being about activity by the user session. Likewise, a characterization of “the user account or the user session” does not mean that both the user account and the user session must be present. Instead, such a characterization is to be understood as a pair of corresponding but distinct characterizations given as alternatives, one characterizing the user account, and the other characterizing the user session.

Storage devices or networking devices or both are considered peripheral equipment in some embodiments and part of a system 102 in other embodiments, depending on their detachability from the processor 110. In some embodiments, other computer systems not shown in FIG. 1 interact in technological ways with the computer system 102 or with another system embodiment using one or more connections to a cloud 134 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include security tools or software applications, mobile devices 102 or workstations 102 or servers 102, editors, compilers, debuggers and other software development tools, as well as APIs, browsers, or webpages and the corresponding software for protocols such as HTTPS, for example. Files, APIs, endpoints, and other resources may be accessed by an account or non-empty set 428 of accounts, user or non-empty group of users, IP address or non-empty group of IP addresses, or other entity. Access attempts may present passwords, digital certificates, tokens or other types of authentication credentials.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory nor a computer-readable storage device is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, volumes, and so forth. Such data is also transformed by backup, restore, commits, aborts, reformatting, and/or other technical operations.

Although an embodiment is described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, some embodiments include one of more of: chiplets, hardware logic components 110, 128 such as Field-Programmable Gate Arrays (FPGAs), Application-Specific Integrated Circuits (ASICs), Application-Specific Standard Products (ASSPs), System-on-a-Chip components, Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUS, and/or quantum processors), memory/storage media 112, peripherals 106, and displays 126, some operating environments also include other hardware 128, such as batteries, buses, power supplies, wired and wireless network interface cards, for instance. The nouns “screen” and “display” are used interchangeably herein. In some embodiments, a display 126 includes one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments, one or more computers are partially or fully “air gapped” by reason of being disconnected or only intermittently connected to another networked device or remote cloud. In particular, ESN functionality 204 could be installed on an air gapped network 108 and then be updated periodically or on occasion using removable media 114, or not be updated at all. Some embodiments also communicate technical data or technical instructions or both through direct memory access, removable or non-removable volatile or nonvolatile storage media, or other information storage-retrieval and/or transmission approaches.

In this disclosure, “semantic” refers to program or program construct meaning, as exemplified, represented, or implemented in program aspects such as data types, data flow, resource usage during execution, and other operational characteristics. In contrast, “syntactic” refers to whether a string of characters is valid according to a programming language definition or program input specification.

One of skill will appreciate that the foregoing aspects and other aspects presented herein under “Operating Environments” form part of some embodiments. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current disclosure.

In any later application that claims priority to the current application, reference numerals may be added to designate items disclosed in the current application. Such items may include, e.g., software, hardware, steps, processes, systems, functionalities, mechanisms, devices, data structures, kinds of data, settings, parameters, components, computational resources, programming languages, tools, workflows, or algorithm implementations, or other items in a computing environment, which are disclosed herein but not associated with a particular reference numeral herein. Corresponding drawings may also be added.

### More About Systems

FIG. 2 illustrates a computing system 102 configured by one or more of the ESN functionality enhancements taught herein, resulting in an enhanced system 202. In some embodiments, this enhanced system 202 includes a single machine, a local network of machines, machines in a particular building, machines used by a particular entity, machines in a particular datacenter, machines in a particular cloud, or another computing environment 100 that is suitably enhanced. FIG. 2 items are discussed at various points herein.

FIG. 3 shows some aspects of some enhanced systems 202. Like FIG. 2, FIG. 3 is not a comprehensive summary of all aspects of enhanced systems 202 or all aspects of ESN functionality 204. Nor is either figure a comprehensive summary of all aspects of an environment 100 or system 202 or other context of an enhanced system 202, or a comprehensive summary of any aspect of functionality 204 for potential use in or with a system 102. FIG. 3 items are discussed at various points herein.

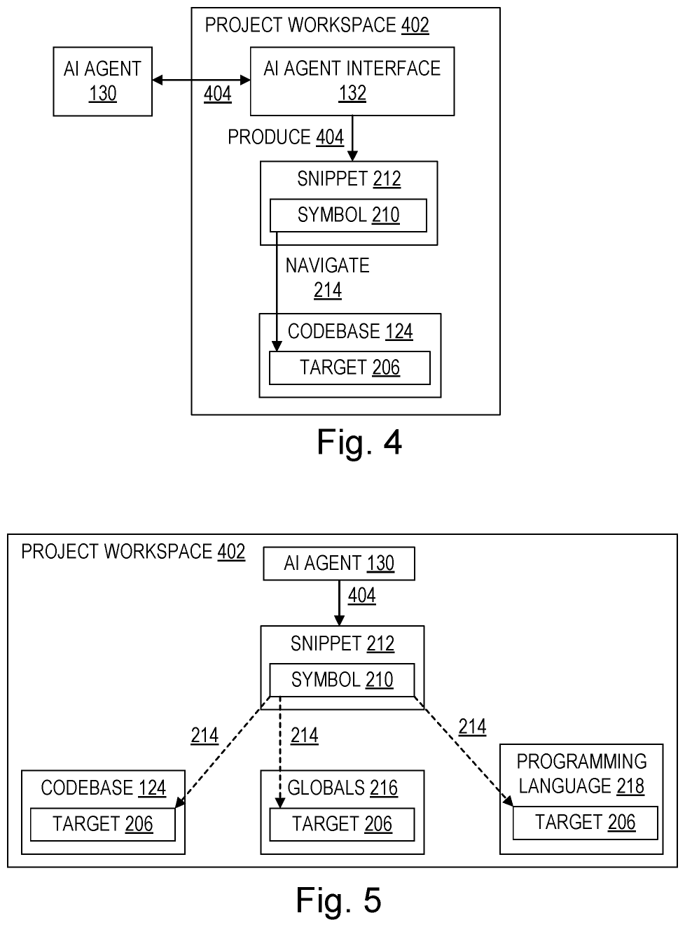

FIG. 4 is a block diagram illustrating aspects of ESN functionality in a first architecture with an artificial intelligence agent outside a project workspace. FIG. 5 is a block diagram illustrating aspects of ESN functionality in a second architecture with an artificial intelligence agent inside a project workspace. Additional architectures, which are not individually shown in respective dedicated figures, combine features and characteristics shown in two or more figures. In particular, some additional architectures are characterized according to whether the AI agent 130 is inside or outside the project workspace 402, and are characterized according to which one, two, or all three of the following are inside the project workspace 402 and also include at least one target 206: a codebase 124, a set of one or more globals 216, or a set of one or more programming language 218 built-in 724 data types, built-in 724 methods 702, or other built-in targets.

In some embodiments, the project workspace 402 contains the code and the active tools used to create, build, debug, modify, test, or otherwise develop 312 a program. An “active” tool 122 is a tool that contains a navigation target 206 of a symbol 210 which appears in the project's codebase 124.

FIGS. 4 and 5 illustrate two examples of project workspaces 402. In FIG. 5, navigation 214 is supported from a symbol 210 into source code of a project codebase 124, into a global (e.g., a JavaScript global variable) 216, or into a programming language definition 218 (e.g., a definition of a built-in type). In FIG. 4, navigation 214 is supported only from a symbol into source code. Some embodiments confirm with a respective one of these figures.

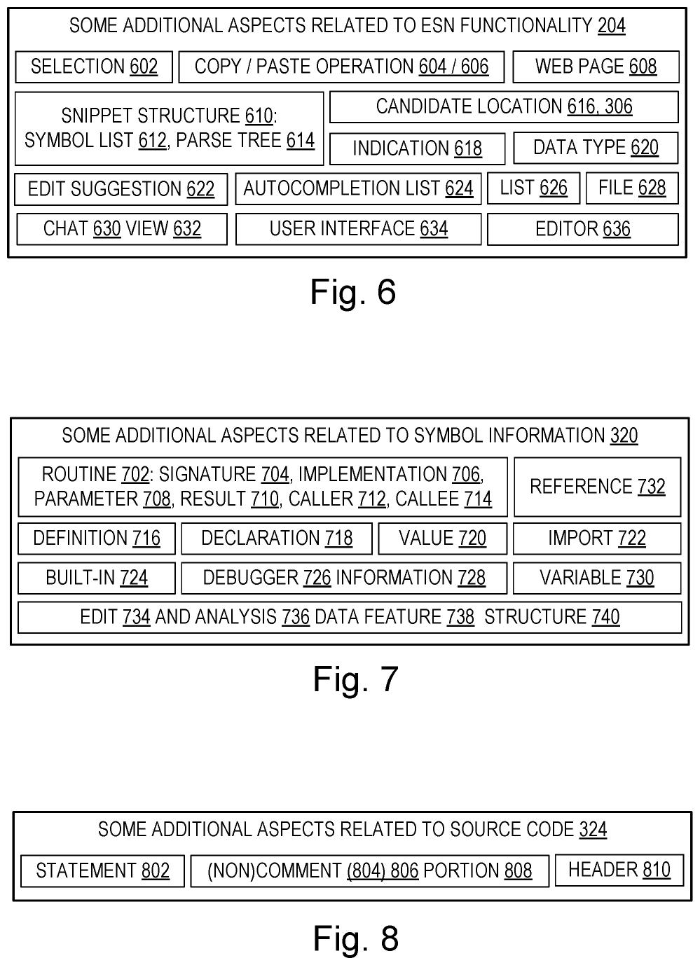

FIG. 6 shows some additional aspects related to ESN functionality 204. This is not a comprehensive summary of all aspects of ESN functionality 204. FIG. 6 items are discussed at various points herein.

FIG. 7 shows some additional aspects related to symbol information 320. This is not a comprehensive summary of all aspects of symbol information 320 or symbols 210. FIG. 7 items are discussed at various points herein.

FIG. 8 shows some additional aspects related to source code 324. This is not a comprehensive summary of all aspects of any source code 324 or any codebase 124 or any programming language 218. Teachings provided herein are applicable in software development environments which support one or more of a variety of programming languages. FIG. 8 items are discussed at various points herein.

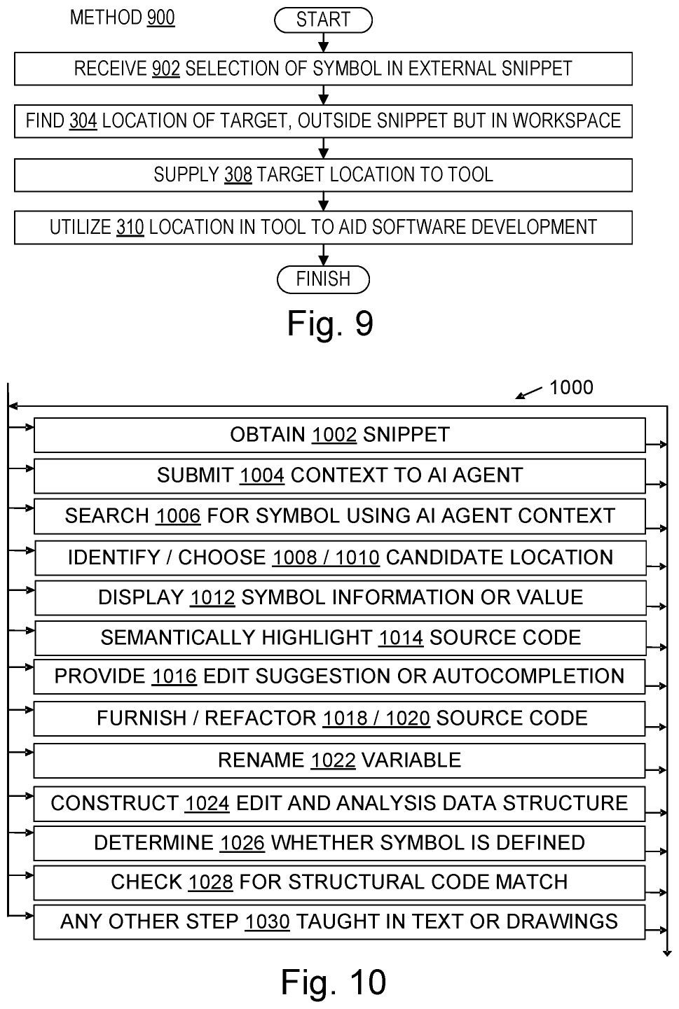

The other figures are also relevant to systems 202. FIGS. 9 and 10 are flowcharts which illustrate some methods of ESN functionality 204 operation in some systems 202.

In some embodiments, the enhanced system 202 is networked through an interface 330. In some, an interface 330 includes hardware such as network interface cards, software such as network stacks, APIs, or sockets, combination items such as network connections, or a combination thereof.

Some embodiments include a computing system 202 which is configured to utilize or provide ESN functionality 204. The system 202 includes a digital memory set 112 including at least one digital memory 112, and a processor set 110 including at least one processor 110. The processor set is in operable communication with the digital memory set. A digital memory set is a set which includes at least one digital memory 112, also referred to as a memory 112. The word “digital” is used to emphasize that the memory 112 is part of a computing system 102, not a human person's memory. The word “set” is used to emphasize that the memory 112 is not necessarily in a single contiguous block or of a single kind, e.g., a memory 112 may include hard drive memory as well as volatile RAM, and may include memories that are physically located on different machines 101. Similarly, the phrase “processor set” is used to emphasize that a processor 110 is not necessarily confined to a single chip or a single machine 101. Sets are non-empty unless described otherwise.

In this example, a project codebase 124 resides in the at least one digital memory 112. The project codebase includes code for building a project's executable 328, e.g., an application program 328, or a kernel 120, 328 that is under development, or a tool 122, 328 that is under development.

In this example, the memory 112 also contains an agent interface 132 to an artificial intelligence agent 130, e.g., an API, or a chat 630 interface 632. The AI agent 130 itself need not reside in the memory 112. Indeed, as shown in FIG. 4 (but not in FIG. 5), in some embodiments the AI agent 130 resides outside a project workspace 402 and hence outside the system 202 of interest. The example system 202 includes the workspace 402. The workspace 402 includes the project codebase 124, the agent interface 132, and a software development tool 122, e.g., an editor 636 or a debugger 726.

In this example, the system 202 includes at least one processor 110 in operable communication with the at least one digital memory. The at least one processor 110 is configured to perform an ESN method 1000, also referred to as a software development method 1000. This method 1000 includes (a) receiving 902 a selection 602 of a symbol 210, the symbol contained in a snippet 212 of source code 324, the snippet situated inside the workspace 402 but outside the codebase 124, (b) finding 304 a location 306 of a target 206, the target related 208 to the symbol, the location outside the snippet and inside the workspace, the location unknown to the software development tool prior to the finding 304, and (c) supplying 308 the location of the target to the software development tool 122.

In at least this example, the source code snippet 212 is a single identifier, or a code fragment (not a full block syntactically), or a block of code, or a non-empty combination of zero or more identifiers, zero or more code fragments, or zero or more blocks of source code. A given snippet 212 does not necessarily match the syntax required to be a block in a given programming language. Thus, in a programming language that defines a code block as consisting of one or more statements 802, a partial statement is not a code block but it is a code snippet 212.

In at least this example, the target is related 208 to the symbol in that the target includes or specifies one or more of: a declaration 718 of the symbol, a definition 716 of the symbol, an instance of the symbol, e.g., a variable 730, a type 620 of the symbol, a name 322 of the symbol (a symbol's name is a string), a reference 732 to the symbol, a caller 712 of the symbol, a callee 714 of the symbol, an implementation 706 of the symbol, an implementation 706 containing the symbol (e.g., an abstract method's implementation), a signature 704 of the symbol, a signature 704 containing the symbol, or another programming artifact which semantically depends on the symbol.

In some embodiments, the target includes at least one of: a declaration 718 of the symbol; a definition 716 of the symbol; a definition 716 of a type 620 of the symbol; a definition 716 of a routine signature 704 of the symbol; an implementation 706 of a routine 702 of the symbol; a reference 732 to the symbol; a multi-member list 626 of all references 732 to the symbol found in the project 326; a caller 712 of the symbol; a callee 714 of the symbol; a multi-member list 626 of all callers 712 of the symbol found in the project; or a multi-member list 626 of all callees 714 of the symbol found in the project. Variations include anywhere from one to all but one of these target examples.

In some embodiments, the target location 306 is in at least one of: a non-comment 804 portion 808 in a source code 324 in the codebase 124 of the project 326; a set 216 of globally defined symbols in the project; a set 218 of programming language built-in symbols; a header 810 file 628 in a source code 324 in the codebase of the project; a symbol definition 716 file 628 in a source code in the codebase of the project; an executable 328 generated at least in part from the codebase of the project; a different snippet 212 obtained via an interface 132 to an artificial intelligence agent 130 prior to receiving the selection 602 of the symbol; or a debugger 726 information 728 file 628, e.g., a .pdb file, a .gdb file, or a similar file.

In some scenarios, navigation 214 with some embodiments leads into code that is not source code, e.g., into executable code or into a .pdb debugger info file. For some programming languages, some embodiments are able to navigate 214 to a header or symbol definition file if they can't access the source code 324. If a target header or symbol definition file is not accessible, some embodiments show the user a location 306 in an executable. Some embodiments apply similar symbol navigation logic during debugging. For instance, some embodiments use ESN functionality 204 to show the current value of variables 730 which are used in chat code blocks 212 during a debugging session, to help a user understand and explore the current state of their program 326.

In some embodiments, the snippet 212 containing the symbol resides in the agent interface 132, and the target location is outside the agent interface. In some embodiments, the snippet 212 containing the symbol resides in a chat view in a user interface of the software development tool. For example, in some scenarios a snippet is produced 404 into an edit window or a chat view of the interface 132 by operation of the AI agent, and a symbol in the snippet has a definition 716, 206 in the project's codebase 124.

In some embodiments, the snippet 212 containing the symbol is a first snippet, the first snippet resides in the agent interface 132, and the target location is in a second snippet 212 which also resides in the agent interface. For example, in some scenarios two snippets are produced into the interface 132 by operation of the AI agent in response to two prompts, and a symbol in one snippet has a definition 716, 206 in the other snippet. In this example, neither snippet is in the codebase 124, but could be added to the codebase 124, possibly after being edited.

In some embodiments, the snippet 212 containing the symbol resides in a source code editor user interface 634 of the software development tool. For example, in some scenarios a snippet is produced into an editor user interface 634 by operation of the AI agent, e.g., as part of an adapted code completion feature 738. Until a proffered suggestion for code completion is actually accepted, the proffered suggestion is not part of the codebase 124. By interactively displaying respective related 208 target information of different proffered suggestion alternatives (e.g., by moving a cursor from item to item in a completion list), an embodiment displays data that distinguishes the alternatives from one another and thus aids selection between the alternatives.

In some embodiments, the target includes an instance of a name 322 of the symbol. For example, in some scenarios a codebase includes a declaration of an identifier, and the codebase uses the identifier elsewhere, but the codebase does not include a definition of the identifier. In C++ for instance, the declaration would be in a header file instead of an implementation file. In scenarios like these, some embodiments respond to a “go to definition” command by stating that no definition was found and by offering options to navigate 214 to the symbol's declaration or the symbol's uses, or both.

In some scenarios, an AI-generated snippet containing a symbol name also contains a definition of the symbol. Some embodiments check for that special case. Although finding a definition locally within a snippet is generally more efficient than attempting to find the symbol's definition outside the snippet, some embodiments do both (look inside the snippet and outside the snippet), because the snippet-local definition is not necessarily the only definition in the workspace 402. In many scenarios, at least one target of a symbol of interest in a snippet from an AI agent is not located in the snippet. Accordingly, some embodiments exclude entirely local code navigation within chat code blocks, for example, by attempting to find target locations related to a symbol outside the snippet that contains the symbol.

Other system embodiments are also described herein, either directly or derivable as system versions of described processes or configured media, duly informed by the extensive discussion herein of computing hardware.

Although specific ESN architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different kinds of ESN functionality, for example, as well as different technical features, aspects, mechanisms, software, expressions, operational sequences, commands, data structures, programming environments, execution environments, environment or system characteristics, proxies, or other functionality consistent with teachings provided herein, and may otherwise depart from the particular examples provided.

Processes (a.k.a. Methods)

Processes (which are also be referred to as “methods” in the legal sense of that word) are illustrated in various ways herein, both in text and in drawing figures. FIGS. 9 and 10 each illustrate a family of methods 900 and 1000 respectively, which are performed or assisted by some enhanced systems, such as some systems 202 or another ESN functionality enhanced system as taught herein. Method family 900 is a proper subset of method family 1000. Moreover, activities identified in FIGS. 2, 3, 4, and 5 include method steps, which are likewise incorporated into method (a.k.a. process) 1000. These diagrams and flowcharts are merely examples; as noted elsewhere, any operable combination of steps that are disclosed herein may be part of a given embodiment when called out in a claim.

Technical processes shown in the Figures or otherwise disclosed will be performed automatically, e.g., by an enhanced system 202, unless otherwise indicated. Related non-claimed processes may also be performed in part automatically and in part manually to the extent action by a human person is implicated, e.g., in some situations a human 104 types or speaks an input such as a particular value for a name 322 of a symbol. Such input is captured in the system 202 as digital text, or captured as digital audio which is then converted to digital text. Regardless, no process contemplated as an embodiment herein is entirely manual or purely mental; none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIG. 10. FIG. 10 is a supplemental portion of the textual and figure drawing examples of embodiments provided herein and the descriptions of embodiments provided herein. In the event of any alleged inconsistency, lack of clarity, or excessive breadth due to an interpretation of FIG. 10, the content of this disclosure shall prevail over that interpretation of FIG. 10.

Arrows in process or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 1000 action items are traversed to indicate the steps performed during a process may vary from one performance instance of the process to another performance instance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with FIG. 10 to be non-operable, the sequence S is not within the scope of any claim. Any assertion otherwise is contrary to the present disclosure.

Some embodiments provide or utilize a software development method 1000 in a computing system 102, e.g., in a computer network 108. This method is performed within a workspace 402 of a current project 326 in the computing system. The current project has a codebase 124. The method 1000 supports navigation 214 from a symbol outside the codebase. The method 1000 includes automatically: receiving 902 a selection of the symbol, the symbol contained in a snippet of source code, the snippet situated inside the workspace but outside the codebase; finding 304 a location of a target, the target related to the symbol, the location outside the snippet and inside the workspace, the location unknown to the software development tool prior to the finding 304; and supplying 308 the location of the target to a software development tool.

In some embodiments, the method includes obtaining 1002 the snippet via an interface 132 to an artificial intelligence agent 130, e.g., after the AI agent 130 produces 404 the snippet into the interface 132 in response to a prompt. Some examples include prompts along the lines of “What is a specific class name to help me write new code to insert into this project?”, “Give me ten examples of how to use this function in my program.”, “Where is folding implemented?”, or “How do I sort in this codebase?” More generally, some prompts to the AI agent will lead the AI agent to generate 404 and output source code which is based on the codebase 124 but not merely excerpted from the codebase 124.

In some embodiments, the method includes obtaining 1002 the snippet via a paste operation 606 which corresponds to a copy operation 604 which was performed on at least one of: a web page 608, or a different project 326 than the current project.

In some embodiments, the symbol has a name 322, the code snippet is in an output 316 produced by an artificial intelligence agent in response to a context 314 submitted 1004 to the artificial intelligence agent, and finding 304 the location of the target includes at least one of: searching 1006 for the symbol name in the context; searching 1006 for the symbol in a symbol list 612 created using a context code snippet from the context; or searching 1006 for the symbol in a parse tree 614 created using a context code snippet from the context. Some examples of context 314 include filenames, symbol names, and code snippets.

In some embodiments, the code snippet is in an output 316 produced by an artificial intelligence agent in response to a context 314 submitted 1004 to the artificial intelligence agent, and finding 304 the location of the target includes: identifying 1008 at least two candidate locations 616 of the target; and choosing 1010 a particular candidate location 61 as the location 306 of the target, the choosing computed from at least one of: an indication 618 whether the particular candidate location is in the context submitted to the artificial intelligence agent, or an indication 618 whether a data type 620 employed at the particular candidate location matches a data type 620 employed in the code snippet.

In some embodiments, the method 1000 includes the software development tool 122 utilizing 310 the location by performing at least one of: displaying 1012 information 320 of the symbol which includes at least one of: a variable type 620, a signature 704, a routine result 710 type 620, a routine parameter 708 name 322, a routine parameter 708 type 620; semantically highlighting 1014 a portion of source code which contains the symbol (the highlighting 1014 is computed according to a semantic analysis of the source code); navigating 214 to the location 306 in a user interface 634 of the software development tool 122; submitting 1004 information about the symbol to an artificial intelligence agent; providing 1016 an edit suggestion 622 for a source code which contains the symbol; providing 1016 an autocompletion list 624 for a source code which contains the symbol; furnishing 1018 a piece of source code which contains a definition of the symbol; furnishing 1018 a source code statement 802 (e.g., with reserved word such as “import” or “include”) to import 722 a definition of the symbol; displaying 1012 a current value 720 of a variable 730 related 208 to the symbol; renaming 1022 a variable 730 which is related 208 to the symbol; or refactoring 1020 a piece of source code which is related 208 to the symbol.

In some embodiments, the target location 306 is in at least one of: a non-comment portion 808 in a source code in the codebase of the project; a set 216 of globally defined symbols in the project; a set 218 of programming language built-in symbols; a header 810 file in a source code in the codebase of the project; a symbol definition 716 file in a source code in the codebase of the project; an executable 328 generated at least in part from the codebase of the project; a different snippet 212 obtained via an interface to an artificial intelligence agent prior to receiving the selection of the symbol, a debugger information 728 file; or a web page 608 outside the project.

### Configured Storage Media

Some embodiments include a configured computer-readable storage medium 112. Some examples of storage medium 112 include disks (magnetic, optical, or otherwise), RAM, EEPROMS or other ROMs, and other configurable memory, including in particular computer-readable storage media (which are not mere propagated signals). In some embodiments, the storage medium which is configured is in particular a removable storage medium 114 such as a CD, DVD, or flash memory. A general-purpose memory, which is removable or not, and is volatile or not, depending on the embodiment, can be configured in the embodiment using items such as ESN software 302, snippet data structures 318, symbol information 320, names 322, edit and analysis data structures 740, and locations 306 in the form of data 118 and instructions 116, read from a removable storage medium 114 and/or another source such as a network connection, to form a configured storage medium. The foregoing examples are not necessarily mutually exclusive of one another. The configured storage medium 112 is capable of causing a computer system 202 to perform technical process steps for providing or utilizing ESN functionality 204 as disclosed herein. The Figures thus help illustrate configured storage media embodiments and process (a.k.a. method) embodiments, as well as system and process embodiments. In particular, any of the method steps illustrated in FIGS. 9 and 10, or otherwise taught herein, may be used to help configure a storage medium to form a configured storage medium embodiment.

Some embodiments use or provide a computer-readable storage device 112, 114 configured with data 118 and instructions 116 which upon execution by a processor 110 cause a computing system 202 to perform a software development method 1000 in a workspace of a project in the computing system, the project having a codebase. This method 1000 includes automatically: receiving 902, via a user interface of a software development tool, a selection of a symbol, the symbol contained in a snippet of source code, the snippet situated inside the workspace but outside the codebase; finding 304 a location of a target, the location outside the snippet and inside the workspace, the target related 208 to the symbol by a relationship 208 including at least one of: a declaration, a definition, a routine implementation, a reference to the symbol, a caller of the symbol, or a callee of the symbol, a data type, a routine signature, a routine result type, a routine parameter name, a routine parameter type; and utilizing 310 the location of the target in the software development tool.

In some embodiments, utilizing 310 the location of the target in the software development tool includes at least one of: displaying 1012, in the user interface, type information related to the symbol; or semantically highlighting 1014, in the user interface, a portion of source code which contains the symbol.

In some embodiments, utilizing 310 the location of the target in the software development tool includes at least one of: providing 1016, in the user interface, an edit suggestion for a source code which contains the symbol; or providing 1016, in the user interface, an autocompletion list for a source code which contains the symbol.

In some embodiments, utilizing 310 the location of the target in the software development tool includes at least one of: furnishing 1018 the codebase with a piece of source code which contains a definition of the symbol; or furnishing 1018 the codebase with a source code statement 802 to import a definition of the symbol. In some scenarios, furnishing 1018 includes providing at least one of: an import statement, an include statement, or an inline definition.

In some embodiments, the software development tool 122 includes a debugger 726, the target includes a variable 730, and utilizing 310 the location of the target in the software development tool includes displaying 1012, in the user interface 634 in the debugger, a current value 720 of the variable.

In some embodiments, utilizing 310 the location of the target in the software development tool includes at least one of: showing 1012 inline information 320 about the symbol, e.g., inlay hints that show parameter names or types in function calls; 1004 feeding back resolved symbol information to an AI agent so that the AI agent can more accurately answer follow up questions about specific parts of the code snippet; providing 1012 the current value of a variable while debugging a program, or enabling renaming 1022 or other refactoring 1020 of symbols in the codebase from the code snippet.

### Additional Observations

Additional support for the discussion of ESN functionality 204 herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, best mode, novelty, nonobviousness, inventive step, or industrial applicability. Any apparent conflict with any other patent disclosure, even from the owner of the present subject matter, has no role in interpreting the claims presented in this patent disclosure. It is in the context of this understanding, which pertains to all parts of the present disclosure, that examples and observations are offered herein.

When interacting with some AI coding assistants, such as the Copilot™ assistant for the VS Code™ tool (marks of Microsoft Corporation), users sometimes ask the AI agent questions about code in their currently opened project, which is sometimes referred to informally as the workspace. The AI agent's response can include code blocks that use symbols (classes, functions, constants, etc.) taken from the workspace. Sometimes these code blocks are taken verbatim from the workspace, but more often these code blocks 212 are generated by the AI agent using the workspace code as a reference context 314. The code blocks are typically shown in an AI chat view in an editor, but the code blocks can also be shown elsewhere, e.g., in VS Code's inline Copilot™ user interface.

Some embodiments described herein help make developers more productive by enabling code navigation—such as go to definition—from inside generated code blocks. For example, a developer can hover over a symbol in the code block and click on it to quickly jump to the symbol's definition in their actual project codebase.

The following example illustrates how this is implemented in some prototype embodiments for navigation to “go to definition” for a workspace symbol used in an AI code block.

Example step 1. Find the symbol the user is interested in inside of an AI response chat block. For example, assume the user clicked on 602 a function called “binarySearch”.

Example step 2. Look through all context from that workspace that was passed to the AI agent in the background and was used to generate the response. This context can include workspace file names, workspace symbol names, and snippets of code from the workspace, for instance.

Example step 3. Using this information, try to resolve the symbol to a set of real code locations in the workspace where the symbol occurs. For workspace symbols in the context, the embodiment looks for exact matches. Finding locations is more complex for the code snippets in the context. For these, the embodiment scans through the snippets to find any occurrences of the target symbol (binarySearch) inside of them. The embodiment uses a parser and AST to make sure it only scans symbols from the snippet and does not match a word inside of a string literal or in a comment.

Example step 4. If the previous step returns a single code location, the embodiment invokes adapted language editing and analysis features 738 to run “go to definition” on that location. This location is pointing to a real file in the workspace, which lets the language editing and analysis features that operate within the codebase work for this search without further adaptation or modification. The definition result from those language editing and analysis features is then returned to the user by the embodiment.

Example step 5. If example step 3 returned multiple candidate locations, the embodiment attempts to resolve the best one. The embodiment prioritizes any symbols that are defined in the workspace context snippets themselves. The embodiment also prioritizes symbols whose types 620 match how the symbol is used in the AI generated code block. The embodiment then uses the language editing and analysis features as in example step 4 to get the definition of the candidate locations, returning the best definition that is resolved.

Some embodiments prioritize an actual definition of a symbol in a block passed 1004 to the AI agent, prioritize matching types 620, prioritize the same programming language, prioritize the same project in a multi-project workspace, or employ a weighted combination of these priorities. In some embodiments, a relevance measure associated by an AI agent with a file is part of a prioritization calculation. In some embodiments, non-test code is prioritized over test suite code, unless a prompt is asking about tests.

Example step 6. If a definition is returned, the editor displays the file and resolved symbol location in the main editor area.

Example note A. The code block symbol the user is navigating to may be defined inside the AI code block itself. In this case, the embodiment in this example finds the local symbol instead of the symbol from the codebase, or finds the symbol from the codebase, or finds both, depending on its preference settings or other configuration data. In some scenarios, before going through all the example steps above the embodiment first passes the entire AI code block to the language editing and analysis features as a virtual document and asks it to resolve the symbol. If the symbol is resolved, the embodiment uses this resolution as the location and skips looking in the codebase for the symbol.

Example note B. In case the AI generates a direct excerpt from code that is present in the workspace, the embodiment first looks at the AI generated code blocks and figures out if any of them match code in the codebase. The embodiment looks for code structure matches instead of exact text matches. This structural matching allows the indentation and formatting of the code to differ, so long as the computational logic itself is the same. If the code block matches code in the codebase, the embodiment creates a mini-editor in a chat view that displays the actual file from the codebase. The embodiment sizes this editor so that it only shows the relevant excerpt from this file. All ESN operations in the code block can then be made directly against the actual codebase file instead of going through the indirection above.

Some embodiments use or provide a software development method which includes: identifying a symbol in a block of source code, the block including a source code output from a language model 130; receiving 902 a navigation request which includes the symbol; determining 1026 whether the symbol is defined within the source code output from the language model; checking 1028 whether the source code output from the language model structurally matches a portion of a code in a workspace; finding 304 a navigation target of the navigation request in a software project, based on at least the results of the determining and the checking; and updating 1012 a software development tool user interface to include the navigation target.

### Internet of Things

In some embodiments, the system 202 is, or includes, an embedded system such as an Internet of Things system. “IoT” or “Internet of Things” means any networked collection of addressable embedded computing or data generation or actuator nodes. An individual node is referred to as an internet of things device 101 or IoT device 101 or internet of things system 102 or IoT system 102. Such nodes are examples of computer systems 102 as defined herein, and may include or be referred to as a “smart” device, “endpoint”, “chip”, “label”, or “tag”, for example, and IoT may be referred to as a “cyber-physical system”. In the phrase “embedded system” the embedding referred to is the embedding a processor and memory in a device, not the embedding of debug script in source code.

IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage-RAM chips or ROM chips provide the only local memory; (e) no CD or DVD drive; (f) being embedded in a household appliance or household fixture; (g) being embedded in an implanted or wearable medical device; (h) being embedded in a vehicle; (i) being embedded in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP, Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

### Technical Character

The technical character of embodiments described herein will be apparent to one of ordinary skill in the art, and will also be apparent in several ways to a wide range of attentive readers. Some embodiments address technical activities such as string searching, structural searching, constructing 1024 edit and analysis data structures 740, semantic highlighting 1014, hovering in a user interface, displaying code snippets in a user interface, and interfacing with an AI agent 130, which are each an activity deeply rooted in computing technology. Some of the technical mechanisms discussed include, e.g., an AI agent 130 interface 132, ESN software 302, edit and analysis features 738, editors 636, and debuggers 726. Some of the technical effects discussed include, e.g., navigating 214 from an external snippet 212 into a project codebase 124, finding 304 a symbol target location 306 in a set 216 of globally definitions, finding 304 a symbol target location 306 in a set 218 of programming language built-ins, automatically and proactively furnishing 1018 import code for a symbol of a snippet 212 that was generated by an AI agent when that snippet is brought into a codebase, and navigating 214 from one AI-generated external snippet 212 into another AI-generated external snippet 212. Thus, purely mental processes and activities limited to pen-and-paper are clearly excluded from the scope of any embodiment. Other advantages based on the technical characteristics of the teachings will also be apparent to one of skill from the description provided.

One of skill understands that ascertaining target locations and related 208 information of a symbol 210 in a software development environment in a computing network 108 or other computing system 102 is technical activity which cannot be performed mentally at all, and cannot be performed manually with the speed and accuracy required in computing systems. Hence, symbol information gathering and navigation technology improvements such as the various examples of ESN functionality 204 described herein are improvements to computing technology. One of skill understands that attempting to manually locate related targets for a symbol would create unacceptable delays in software development, and introduce unnecessary and unacceptable human errors. People manifestly lack the speed, accuracy, memory capacity, and specific processing capabilities required to perform external symbol navigation as taught herein.

One who is not skilled in the art of software development might assert that the meanings associated with a given symbol could be deduced by a developer who has gathered and reviewed the source code C1 which contains the symbol, plus the source code C2 that code C1 references, plus the source code C3 that code C2 references, and so on, up to and including a potentially very large collection of source code that is self-contained with respect to the given symbol and with respect to every symbol that is related 208 to the given symbol. But any person skilled in the art of software development would understand that in practice this unproven and vague-on-details theoretical approach would be too slow, incomplete, error-prone, and uninformative to be sufficient as an implementable technology.

Different embodiments provide different technical benefits or other advantages in different circumstances, but one of skill informed by the teachings herein will acknowledge that particular technical advantages will likely follow from particular embodiment features or feature combinations, as noted at various points herein. Any generic or abstract aspects are integrated into a practical application such as an AI-assisted code editor, an AI-assisted debugger, an integrated development environment, or another software development tool.

Some embodiments described herein may be viewed by some people in a broader context. For instance, concepts such as efficiency, reliability, user satisfaction, or waste may be deemed relevant to a particular embodiment. However, it does not follow from the availability of a broad context that exclusive rights are being sought herein for abstract ideas; they are not.

Rather, the present disclosure is focused on providing appropriately specific embodiments whose technical effects fully or partially solve particular technical problems, such as how to leverage an adapted language edit and analysis feature 738 to find targets related to a symbol in a generated code snippet, how to improve user-directed navigation from a symbol in an AI-generated code into a project workspace, how to correlate a symbol in an AI-generated code snippet with uses of the symbol outside the AI-generated code snippet in project workspace code 124, and how to avoid build errors when copying AI-generated code into a codebase. Other configured storage media, systems, and processes involving efficiency, reliability, user satisfaction, or waste are outside the present scope. Accordingly, vagueness, mere abstractness, lack of technical character, and accompanying proof problems are also avoided under a proper understanding of the present disclosure.

### Additional Combinations and Variations

Any of these combinations of software code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, language models, prompts, motivating examples, operating environments, tools, peripherals, software process flows, identifiers, repositories, data structures, data selections, naming conventions, notations, control flows, or other implementation choices described herein. Any apparent conflict with any other patent disclosure, even from the owner of the present subject matter, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
AST: abstract syntax tree
BIOS: basic input/output system
CD: compact disc
CLI: command line interface, command line interpreter
CPU: central processing unit
DLL: dynamic link library
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
IDE: integrated development environment
LAN: local area network
OS: operating system
PaaS or PAAS: platform-as-a-service
RAM: random access memory
ROM: read only memory
SIEM: security information and event management
TPU: tensor processing unit
UEFI: Unified Extensible Firmware Interface
UI: user interface
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Sharing a reference numeral does not mean necessarily sharing every aspect, feature, or limitation of every item referred to using the reference numeral. Omission of a reference numeral from a given piece of text does not necessarily mean that the content of a Figure is not being discussed by the text. The present disclosure asserts and exercises the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

A snippet 212 from an AI agent is referred to herein as an “AI-produced” snippet, an “AI-generated” snippet, or an “AI-excerpted” snippet. An AI-excerpted snippet in a project 326 is a snippet produced by an AI agent that matches code in the project's codebase 124; the match is either exact (including indentation and other formatting) or the match is at least structural (same identifiers, same Abstract Syntax Tree). An AI-generated snippet in a project 326 is a snippet produced by an AI agent that is not AI-excerpted—the snippet was synthesized or otherwise generated by the AI Agent and does not match code in the project codebase. An AI-produced snippet is either an AI-excerpted snippet or an AI-generated snippet.

“Service” as a noun means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

Herein, activity by a user refers to activity by a user device or activity by a user account or user session, or by software on behalf of a user, or by hardware on behalf of a user. Activity is represented by digital data or machine operations or both in a computing system. Activity within the scope of any claim based on the present disclosure excludes human actions per se. Software or hardware activity “on behalf of a user” accordingly refers to software or hardware activity on behalf of a user device or on behalf of a user account or a user session or on behalf of another computational mechanism or computational artifact, and thus does not bring human behavior per se within the scope of any embodiment or any claim.

“Digital data” means data in a computing system, as opposed to data written on paper or thoughts in a person's mind, for example. Similarly, “digital memory” refers to a non-living device, e.g., computing storage hardware, not to human or other biological memory.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” may also be used as a patent law term of art, e.g., in describing a process claim as opposed to a system claim or an article of manufacture (configured storage medium) claim. Similarly, “method” is used herein primarily as a technical term in the computing science arts (a kind of “routine”) but it is also a patent law term of art (akin to a “method”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. ESN operations such as finding 304 target locations, navigating 214 to a target location, utilizing 310 a target location in a tool, and many other operations discussed herein (whether recited expressly in the Figures or not), are understood to be inherently digital and computational. A human mind cannot interface directly with a CPU or other processor, or with RAM or other digital storage, to read and write the necessary data to perform the ESN steps 1000 taught herein even in a hypothetical situation or a prototype situation, much less in an embodiment's real world large computing environment, e.g., an internet-connected environment. This would all be well understood by persons of skill in the art in view of the present disclosure. Moreover, one of skill understands that ESN functionality cannot be implemented merely with conventional tools and steps, because actual implementation requires the use of teachings which were first provided in the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user, and indicates machine activity rather than human activity. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities; it is provided merely to aid understanding of the scope of “at least one” that is intended herein.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this disclosure discusses various data values and data structures, and recognize that such items reside in a memory (RAM, disk, etc.), thereby configuring the memory. One of skill will also recognize that this disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational step on behalf of a party of interest, such as analyzing, calling, chatting, checking, choosing, constructing, debugging, declaring, defining, determining, displaying, editing, extracting, finding, furnishing, highlighting, identifying, importing, indicating, navigating, obtaining, producing, providing receiving, refactoring, renaming, searching, submitting, supplying, utilizing (and analyzes, analyzed, calls, called, etc.) with regard to a destination or other subject may involve intervening action, such as the foregoing or such as forwarding, copying, uploading, downloading, encoding, decoding, compressing, decompressing, encrypting, decrypting, authenticating, invoking, and so on by some other party or mechanism, including any action recited in this document, yet still be understood as being performed directly by or on behalf of the party of interest. Example verbs listed here may overlap in meaning or even be synonyms; separate verb names do not dictate separate functionality in every case.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other storage device or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory and computer readable storage devices are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### Remarks Regarding Reference Numerals

Reference numerals are provided for convenience and in support of the drawing figures and as part of the text of the specification, which collectively describe aspects of embodiments by reference to multiple items. Items which do not have a unique reference numeral may nonetheless be part of a given embodiment. For better legibility of the text, a given reference numeral is recited near some, but not all, recitations of the referenced item in the text. The same reference numeral may be used with reference to different examples or different instances of a given item.

The following remarks pertain to particular reference numerals:
100 operating environment, also referred to as computing environment; includes one or more systems 102
101 machine in a system 102, e.g., any device having at least a processor 110 and having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202
106 peripheral device
108 network generally, including, e.g., LANs, WANs, software-defined networks, clouds, and other wired or wireless networks
110 processor or non-empty set of processors; includes hardware
112 computer-readable storage medium, e.g., RAM, hard disks; also referred to as storage device
114 removable configured computer-readable storage medium
116 instructions executable with processor; may be on removable storage media or in other memory (volatile or nonvolatile or both)
118 digital data in a system 102; data structures, values, source code, and other examples are discussed herein
120 kernel(s), e.g., operating system(s), BIOS, UEFI, device drivers; also refers to an execution engine such as a language runtime
122 software tools, software applications, security controls; hardware tools; computational
126 display screens, also referred to as “displays”
128 computing hardware not otherwise associated with a reference numeral 106, 108, 110, 112, 114
130 artificial intelligence agent, also referred to as AI agent; a language model is an example; other examples include foundation models, statistical models, expert systems, multimodal language models, and large language models
134 cloud, also referred to as cloud environment or cloud computing environment
202 enhanced computing system, i.e., system 102 enhanced with functionality 204 as taught herein
204 external symbol navigation functionality (also referred to as ESN functionality 204, or functionality 204), e.g., software or specialized hardware which performs or is configured to perform steps 304 and 310, or steps 304 and 308, or any software or hardware which performs or is configured to perform a code navigation, code edit, or code analysis activity first disclosed herein, or to perform a novel method 1000 first disclosed herein; the “navigation” in external symbol navigation is illustrative not prescriptive, because ESN also refers to analysis 736 or editing 734 with external symbols as taught herein
206 target, also referred to as “navigation targets”, as represented in a computing system; although some examples involve navigating 214 from a symbol in an AI-produced snippet to a definition of the symbol in a project codebase, definitions are not the only possible navigation targets; some embodiments support navigation from an external snippet outside a codebase into the codebase that corresponds to one of more of: Go to Definition, Go to Type Definition, Go to Implementation, and Go to Symbol
210 symbol, as represented in a computing system, e.g., a class, type, method, method property, variable, routine (procedure or function), constant, or programmer-defined operator; this definition of “symbol” governs over other definitions in the theory or practice of software development, e.g., it governs over definitions of symbol some programming languages such as Lisp and Ruby, and it governs over the way “symbol” is used in produce literature, e.g., VS Code documentation; depending on the context, “symbol” refers to the string identifier (a.k.a. name) of the symbol or to another representation of the symbol in a computing system such as a data structure containing the symbol's current value when the symbol's name corresponds to a variable
306 target location, as represented in a computing system, e.g., by a pointer, URL, filename and line number, filename and offset, index, or other address; targets are located within the workspace 402 unless stated otherwise; some embodiments additionally provide a link to information outside a workspace, e.g., a developer network web page, or a target location in a current code block in an AI chat conversation, or a target location in an earlier code block in the AI chat conversation
900 flowchart; 900 also refers to ESN methods that are illustrated by or consistent with the FIG. 9 flowchart or any variation of the FIG. 9 flowchart described herein; all ESN method steps are computational, not human activity
1000 flowchart; 1000 also refers to ESN methods that are illustrated by or consistent with the FIG. 10 flowchart, which incorporates the FIG. 9 flowchart, the steps in FIGS. 2, 3, 4, and 5, and all other steps taught herein, or methods that are illustrated by or consistent with any variation of the FIG. 10 flowchart described herein; all ESN method steps are computational, not human activity
1030 any step or item discussed in the present disclosure that has not been assigned some other reference numeral; 1030 may thus be shown expressly as a reference numeral for various steps or items or both, and may be added as a reference numeral (in the current disclosure or any subsequent patent application which claims priority to the current disclosure) for various steps or items or both without thereby adding new matter

### CONCLUSION

Some embodiments find 304 locations 306 of targets 206 which are related 208 to a symbol 210 in a source code snippet 212, when the snippet is external to a project 326 codebase 124. Finding a target's location allows user-directed or proactive automatic navigation 214 from the symbol 210 into the codebase, display 1012 of data type 620, signature 704, and other semantic information 320 of the symbol, proactive automatic creation 1018 of an import statement 722 for a definition 716 of the symbol, and other utilizations 310 of the target location in an enhanced editor 636 or enhanced debugger 726 or another software development 312 tool 122. In some scenarios, the external snippet 212 is generated by an artificial intelligence agent 130, using part of the codebase as context 314. Some embodiments find 304 a target 206 of an external snippet's symbol in another external snippet 212, allowing a tool utilization 310 that is informed by the project codebase 124 even when both snippets 212 are outside the project codebase.

Embodiments are understood to also themselves include or benefit from tested and appropriate security controls and privacy controls such as the General Data Protection Regulation (GDPR). Use of the tools and techniques taught herein can be used together with such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of platforms or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; it is not required to recite every nuance within the claims themselves as though no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A software development method performed within a workspace of a project in a computing system, the project having a codebase, the method comprising automatically:
receiving, at a software development tool, a selection of a symbol, the symbol contained in a snippet of source code, the snippet situated inside the workspace but outside the codebase;
finding a location of a target, the target related to the symbol, the location outside the snippet and inside the workspace, the location unknown to the software development tool prior to the finding; and
supplying the location of the target to the software development tool.

2. The method of claim 1, further comprising obtaining the snippet via an interface to an artificial intelligence agent.

3. The method of claim 1, further comprising obtaining the snippet via a paste operation which corresponds to a copy operation which was performed on at least one of: a web page, or a different project.

4. The method of claim 1, wherein the symbol has a name, the code snippet is in an output produced by an artificial intelligence agent in response to a context submitted to the artificial intelligence agent, and finding the location of the target comprises at least one of:
searching for the symbol name in the context;
searching for the symbol in a symbol list created using a code snippet from the context; or
searching for the symbol in a parse tree created using a code snippet from the context.

5. The method of claim 1, wherein the code snippet is in an output produced by an artificial intelligence agent in response to a context submitted to the artificial intelligence agent, and finding the location of the target comprises:
identifying at least two candidate locations of the target; and
choosing a particular candidate location as the location of the target, the choosing computed from at least one of: an indication whether the particular candidate location is in the context submitted to the artificial intelligence agent, or an indication whether a data type employed at the particular candidate location matches a data type employed in the code snippet.

6. The method of claim 1, further comprising the software development tool utilizing the location by performing at least one of:
displaying information of the symbol which includes at least one of: a variable type, a signature, a routine result type, a routine parameter name, a routine parameter type;
highlighting a portion of source code which contains the symbol, the highlighting computed according to a semantic analysis of the source code;
navigating to the location in a user interface of the software development tool;
submitting information about the symbol to an artificial intelligence agent;
providing an edit suggestion for a source code which contains the symbol;
providing an autocompletion list for a source code which contains the symbol;
furnishing a piece of source code which contains a definition of the symbol;
furnishing a source code statement to import a definition of the symbol;
displaying a current value of a variable related to the symbol;
renaming a variable which is related to the symbol; or
refactoring a piece of source code which is related to the symbol.

7. The method of claim 1, wherein the target location is in at least one of:
a non-comment portion in a source code in the codebase of the project;
a set of globally defined symbols in the project;
a set of programming language built-in symbols;
a header file in a source code in the codebase of the project;
a symbol definition file in a source code in the codebase of the project;
an executable generated at least in part from the codebase of the project;
a different snippet obtained via an interface to an artificial intelligence agent prior to receiving the selection of the symbol;
a debugger information file; or
a web page outside the project.

8. A computing system, comprising:
at least one digital memory;
a project codebase residing in the at least one digital memory;
an agent interface to an artificial intelligence agent;
a workspace, the workspace comprising the project codebase, the agent interface, and a software development tool;
at least one processor in operable communication with the at least one digital memory, the at least one processor configured to perform a software development method which comprises (a) receiving a selection of a symbol, the symbol contained in a snippet of source code, the snippet situated inside the workspace but outside the codebase, (b) finding a location of a target, the target related to the symbol, the location outside the snippet and inside the workspace, and (c) supplying the location of the target to the software development tool.

9. The computing system of claim 8, wherein the target includes at least one of:
a declaration of the symbol;
a definition of the symbol;
a definition of a type of the symbol;
a definition of a routine signature of the symbol;
an implementation of a routine of the symbol;
a reference to the symbol;
a multi-member list of all references to the symbol found in the project;
a caller of the symbol;
a callee of the symbol;
a multi-member list of all callers of the symbol found in the project; or
a multi-member list of all callees of the symbol found in the project.

10. The computing system of claim 8, wherein the target location is in at least one of:
a non-comment portion in a source code in the codebase of the project;
a set of globally defined symbols in the project;
a set of programming language built-in symbols;
a header file in a source code in the codebase of the project;
a symbol definition file in a source code in the codebase of the project;
an executable generated at least in part from the codebase of the project;
a different snippet obtained via an interface to an artificial intelligence 20 agent prior to receiving the selection of the symbol; or
a debugger information file.

11. The computing system of claim 8, wherein the snippet containing the symbol resides in the agent interface, and the target location is outside the agent interface.

12. The computing system of claim 8, wherein the snippet containing the symbol is a first snippet, the first snippet resides in the agent interface, and the target location is in a second snippet which also resides in the agent interface.

13. The computing system of claim 8, wherein the snippet containing the symbol resides in a chat view in a user interface of the software development tool.

14. The computing system of claim 8, wherein the snippet containing the symbol resides in a source code editor user interface of the software development tool.

15. The computing system of claim 8, wherein the target includes an instance of a name of the symbol.

16. A computer-readable storage device configured with data and instructions which upon execution by a processor perform a software development method in a workspace of a project in a computing system, the project having a codebase, the method comprising automatically:
receiving, via a user interface of a software development tool, a selection of a symbol, the symbol contained in a snippet of source code, the snippet situated inside the workspace but outside the codebase;
finding a location of a target, the location outside the snippet and inside the workspace, the target related to the symbol by a relationship comprising at least one of: a declaration, a definition, a routine implementation, a reference to the symbol, a caller of the symbol, or a callee of the symbol, a data type, a routine signature, a routine result type, a routine parameter name, a routine parameter type; and
utilizing the location of the target in the software development tool.

17. The computer-readable storage device of claim 16, wherein utilizing the location of the target in the software development tool comprises at least one of:
displaying, in the user interface, type information related to the symbol; or
semantically highlighting, in the user interface, a portion of source code which contains the symbol.

18. The computer-readable storage device of claim 16, wherein utilizing the location of the target in the software development tool comprises at least one of:
providing, in the user interface, an edit suggestion for a source code which contains the symbol; or
providing, in the user interface, an autocompletion list for a source code which contains the symbol.

19. The computer-readable storage device of claim 16, wherein utilizing the location of the target in the software development tool comprises at least one of:
furnishing the codebase with a piece of source code which contains a definition of the symbol; or
furnishing the codebase with a source code statement to import a definition of the symbol.

20. The computer-readable storage device of claim 16, wherein the software development tool comprises a debugger, the target comprises a variable, and utilizing the location of the target in the software development tool comprises displaying, in the user interface in the debugger, a current value of the variable.
